(19) United States
(12) Patent Application Publication
(10) Pub. No.: US 2016/0100469 A1
(43) Pub. Date: Apr. 7, 2016

(54) LIGHTING DEVICE HAVING DIFFERENT OLEDS IN SERIES AND SHUNTING SWITCH FOR SUBSET OF OLEDS

(71) Applicant: OLEDWorks GmbH, Aachen (DE)

(72) Inventors: Liang SHI, Shanghai (CN); Zhong HUANG, Shanghai (CN); Jun LU, Shanghai (CN); Gang DING, Shanghai (CN); Gang WANG, Shanghai (CN)

(21) Appl. No.: 14/953,380

(22) Filed: Nov. 29, 2015

Related U.S. Application Data
(63) Continuation of application No. PCT/IB2014/061462, filed on May 15, 2014.
Application No. PCT/IB2014/061462 is a continuation of application No. PCT/CN2013/076458, filed on May 30, 2013.

(30) Foreign Application Priority Data
May 30, 2013 (CN) PCT/CN2013/076458

(51) Int. Cl. H05B 33/08

(52) U.S. Cl. CPC H05B 33/0896

(57) ABSTRACT

A lighting device is described. The lighting device 10 comprises at least a first OLED module 14a, 14b with a first OLED element 28a and a second OLED module 16a, 16b, 16c with a second OLED element 28b. The OLED elements include a front surface for emitting light, and a back surface. The front surfaces of the first and second OLED elements have different size. A power supply circuit 38 supplies a series operating current I_{S}. The OLED modules 14a, 14b, 16a-c, are electrically connected in series to the power supply circuit 38 to be operated by the series operating current I_{S}. In order to efficiently operate different OLED elements within the lighting device, an adjustment circuit 40 is provided to adjust a second operating current I₂ supplied to the second OLED element 28b to a current value below a current value of the series operating current I_{S}.

### TECHNICAL FIELD OF THE INVENTION

The invention relates to a lighting device. In particular, the invention relates to lighting devices which include OLEDs.

### BACKGROUND OF THE INVENTIONS

OLED technology has significantly advanced such that today OLED elements start to become available which are suited for lighting applications. OLED elements include a layer of organic semiconductive material which is driven as an electroluminescent layer to emit light.

Lighting devices intended for general lighting applications, i. e. for illumination of a room, space etc., generally have to fulfill certain requirements both regarding the geometric parameters such as size and shape as well as illumination parameters, such as luminous flux. One possible approach to satisfy these requirements is to design, for each lighting task, a single custom OLED element or module of required geometrical and illumination properties. However, this concept is not very flexible and requires an extra design for any of several different required types of lighting devices.

WO 2009/048951 A2 describes a method and apparatus for controlling load currents of multiple series-connected loads. In an embodiment, the apparatus is a luminaire comprising multiple series-connected LED loads to provide coloured and/or white light having a variety of colours. The apparatus includes a power supply and control electronics that provide an operating voltage for the LED light sources, which are connected in series.

The LED light sources are of different types having different spectra of emitted light. The power supply includes a load control stage to control a flow of the series current, including a controllable current path coupled between the different LEDs so as to partially divert the series current around one of the LED. The controllable current pass may be controlled based on a temperature signal.

### SUMMARY OF INVENTION

It may be considered an object of the invention to provide an OLED lighting device with a very flexible design for different lighting tasks.

This object is solved by a lighting device according to claim 1. Dependent claims refer to preferred embodiments of the invention.

According to an aspect of the invention, the lighting device comprises more than one OLED module, specifically at least a first and a second OLED module. Each OLED module includes at least one OLED element, which may preferably be of flat shape and include front and back surfaces. In the present context, the light emitting surface will be referred to as the front surface, whereas the back surface of the OLED element is the surface opposite to the front surface. While the term “OLED element” refers to the actual light emitting part and decisive electrical component, i.e generally preferred an OLED board with an organic luminous layer, the term “OLED module” shall refer to a physical unit, which may comprise further elements of mechanical nature (e.g. a module housing) and/or electrical nature (e.g. connector plugs, conductors and/or circuitry). In the simplest case, an OLED module may also be comprised of the OLED element alone, if no further parts are necessary.

Each OLED element may be operated by supplying electrical power thereto, specifically to electrical terminals provided for this purpose. According to the generally known structure of an OLED element, such terminals may be connected to electrodes provided adjacent to the organic semiconductor layer. In the context of the present invention, the specifics of the internal structure of the OLED elements, such as the material of the organic compound or of the electrodes, will not be further discussed.

According to an aspect of the invention, at least the first and the second OLED elements are different with regard to their size; in particular have a different surface area of the respective front surfaces. As will be appreciated by the skilled person, the first and second OLED elements may differ by their shape and dimensions. As will become apparent in connection with preferred embodiments, the invention is not limited to lighting devices comprising only two different OLED modules or elements; in fact, it may be preferred to provide, within the lighting device, several OLED modules or elements of two or more different types.

Combining such different OLED modules or elements together in a lighting device allows for a very flexible design, and facilitates to provide lighting devices for different lighting tasks, i. e. of different dimensions. For example, the first OLED device (or: first type of several OLED modules in the lighting device) may comprise a relatively large, e.g. rectangular OLED element, whereas the second OLED module (or: second type of several OLED modules in the lighting device) may comprise an OLED element of substantially smaller surface area, e. g. of square shape.

Such different OLED modules with OLED elements of different shape and size allow efficient combinations suitable for a variety of different lighting tasks. For example, a lighting device suited for a lighting tasks demanding a certain overall length or area may be made up of a combination of OLED modules with larger OLED elements to fill the largest part of the required length or area, and one or more OLED devices with smaller OLED elements to fill the rest of the required length or area.

Thus, the concept of using differently shaped and/or sized OLED elements is quite flexible. To obtain efficient combinations, it is in particular proposed to provide a first OLED element that is at least 50% larger than the second OLED element, preferably more than 100% larger in area. Particularly preferred, the surface area of the front surface of the first OLED element is more than twice the size of the surface area of the front surface of the second OLED element. Such a relatively large difference in size between the OLED elements allows to fill a required overall size of a lighting device quite efficiently. For embodiments where the OLED elements and modules are arranged in a line one behind the other, it is particularly preferred to provide first and second OLED elements of the same width, but of different length.

While it is generally possible that the different OLED modules and elements may have different spectra of emitted light, i.e. provide light of different color, it is preferred to provide first and second OLED devices which emit light of the same color, such that the front of the lighting device will appear as a unitary light emitting surface.

According to an aspect of the invention, the different OLED modules are commonly supplied with electrical power by a power supply circuit. The power supply circuit supplies a series operating current I_{S} and the OLED modules are electrically connected in series to the power supply to be operated by the series operating current I_{S}.

As explained above, the OLED elements of the first and second OLED modules differ in their geometrical parameters, and may preferably also differ in their electrical parameters, i. e. require different nominal current. To be able to obtain such different nominal currents despite the chosen series connection, there is provided, according to an aspect of the invention, an adjustment circuit to deliver a second operating current I₂ to the second OLED element. The current value of the second operating current I₂ is adjusted by the adjustment circuit to a value below the current value of the series operating circuit I_{S}.

This design thus allows to drive different OLED modules and elements in a series connection. Thus, the invention provides for a very simple design of a lighting device, which is however quite flexible with regard to combination of different OLED modules and elements.

According to a preferred embodiment of the invention, an OLED module may comprise at least one OLED element which includes terminals for electrical supply. A conductor board, which comprises electrical conductors connected—directly or indirectly—to the power supply circuit, may be arranged in parallel to the back surface of the OLED element, and the terminals of the OLED element may be connected to the conductors of the conductor board. Thus, according to this preferred embodiment, electrical connection within the OLED modules effected by a flat conductor board, which may e.g. be a printed circuit board (PCB). This allows to provide electrical connection without wires. The OLED modules may thus be comprised of the OLED elements and conductor boards.

In a particularly preferred embodiment, at least two of the OLED modules are electrically connected by plug connectors. Thus, even between the individual OLED devices, no separate wires are necessary. This further provides for efficient manufacturing.

In a further preferred embodiment, the electrical contact between a conductor board and an OLED element may be effected by contact springs. In this case, electrical terminals are provided on the back surface of an OLED element. The contact springs are arranged between these terminals and electrical conductors on the conductor board. In particular, the contact springs may be provided as bent metal sheet elements, which are provided between the conductor board and the backside of the OLED element.

It is preferred to arrange the OLED modules within a common housing or frame. In particular, a top housing may be provided as a frame to hold the OLED modules without covering the front surface.

With regard to power supply and electrical connection, it has already been explained that the first and second OLED modules are driven by a series operating current. It is preferred that the OLED element of the first OLED module is directly operated by this series operating current, i.e. that no further switching or other current conversion circuits need to be provided. In preferred embodiments, not only the OLED element of the first OLED module, but a plurality of OLED modules with OLED elements of the same type and, in particular of the same size, are directly operated by the series operating current.

On the other hand the OLED element of the second OLED module is driven by a second operating current I₂ lower than the series operating current I_{S}. According to a preferred aspect, the adjustment circuit may comprise a controllable bypass element to bypass at least a portion of the series operating current I_{S} from the second OLED element. In other words, the OLED element of the second OLED module provided in the series circuit may be partially bridged by the controllable bypass element, such that the second operating current I₂ flowing through it is reduced with regard to the series operating current I_{S}.

According to a preferred embodiment, a control circuit is provided for controlling the controllable bypass element. Control may be effected in dependence on the current through the second OLED element, i.e. on the second operating current. In particular, feedback control may be employed to limit the second operating current to a current value below the series operating current. To effect feedback control, it is particularly preferred to provide a current sensing element which is electrically connected in series with the second OLED element, and which thus allows to sense the value of the second device current. The current sensing element may e.g. be a resistor.

In one embodiment, the adjustment circuit may comprise a DC/DC driver circuit, which is supplied with electrical power by the series operating current, and which provides the second operating current to the second OLED module or element. The DC/DC driver circuit may thus serve to adjust the second operating current to a desired value as necessitated by the second OLED element. Various types of DC/DC drivers are per se known to the skilled person. In particular, controllable switching DC/DC converters are preferred, where a plurality of topologies such as e.g. a buck converter may be used.

These and other aspects of the invention will become apparent from and elucidated with reference to the embodiment described herein after.

### BRIEF DESCRIPTION OF THE DRAWINGS

In the drawings,

FIG. 1 shows a perspective view of an embodiment of a lighting device;

FIG. 2 shows a bottom view of the lighting device of FIG. 1;

FIG. 3 shows a side view of the lighting device of FIG. 1, FIG. 2;

FIG. 4 shows a perspective exploded view of the lighting device of FIGS. 1-3;

FIG. 5 shows a schematic representation of an electrical circuit of the lighting device of FIGS. 1-4 including an adjustment circuit;

FIG. 6 shows a first embodiment of an adjustment circuit;

FIG. 7 shows a second embodiment of an adjustment circuit.

### DESCRIPTION OF EMBODIMENTS

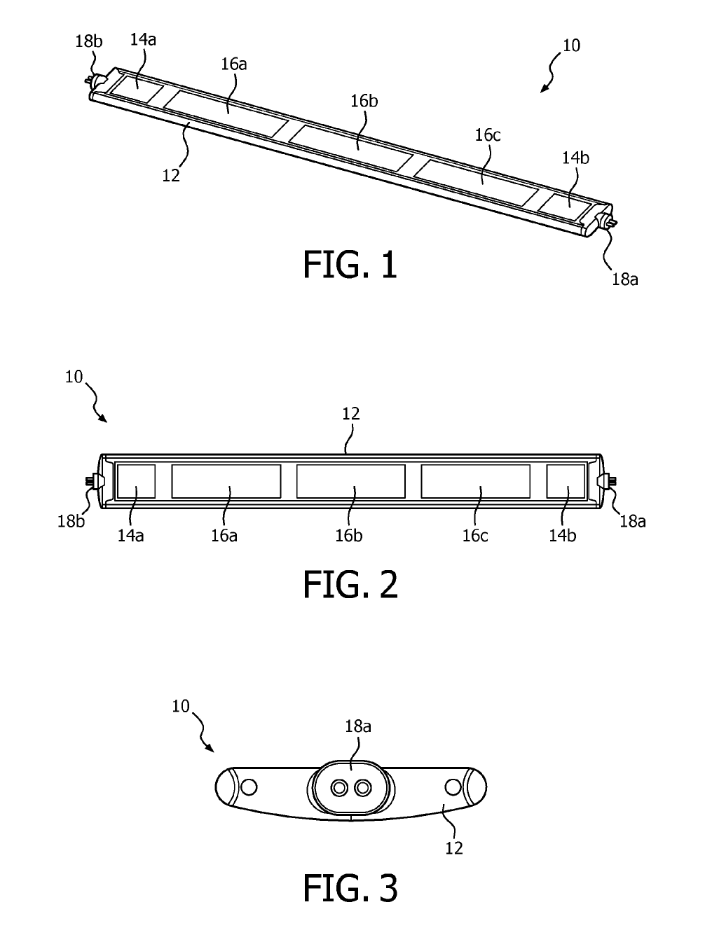

As shown in FIGS. 1 and 2, a lighting device 10 includes, within a housing 12, OLED modules, 14a, 14b, 16a, 16b, 16c.

In the shown example, the lighting device 10 of FIGS. 1-3 is of elongate shape and provided with electrical plug connectors 18a, b on both ends. Over the length of the lighting device 10, three large OLED modules 16a, 16b, 16c of a first type are arranged together with two smaller OLED modules 14a, 14b of a second type.

This arrangement of OLED modules 14a, 14b, 16a-16c is shown exemplary only for the specific lighting device 10. The lighting device 10 is intended to be used as a lamp for general lighting applications, which may be fitted at the plug connectors 18a, 18b into corresponding luminaires. In particular, the proposed embodiment is intended as a retrofit lamp replacing previous fluorescent lamps.

Since various types of fluorescent lamps are required, characterized e.g. by different lengths, the present invention intends to provide an efficient and flexible structure for lighting devices 10 which may serve as replacement of fluorescent lamps of different sizes. Thus, beside the one example of a lighting devide 10 shown in FIGS. 1-3, several different types of lighting devices may be provided with different lengths. In these different types there may be provided a different number of smaller and larger OLED modules to fit the overall length of the lighting device.

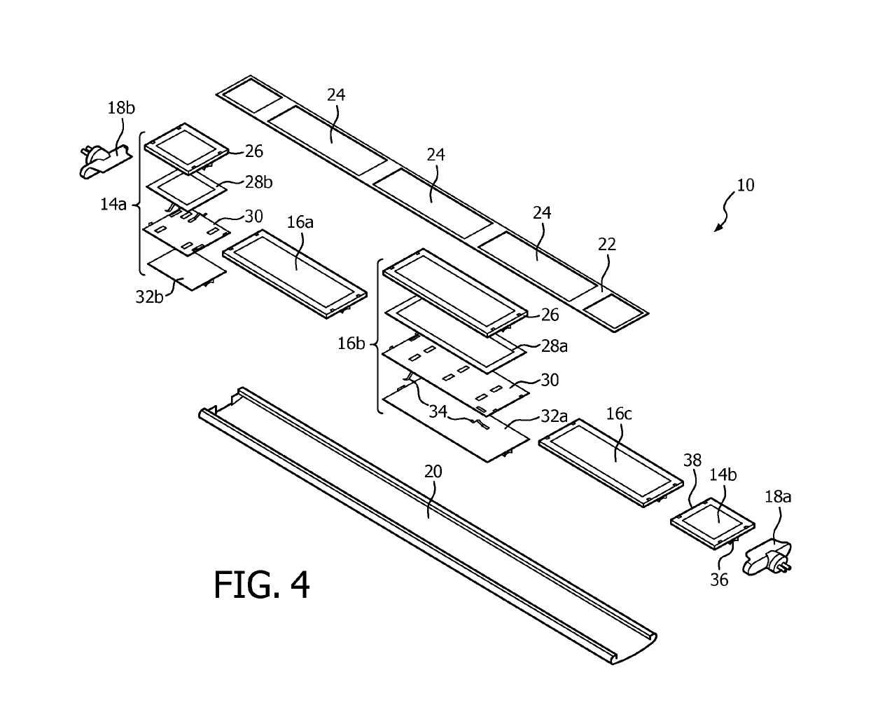

FIG. 4 shows the structure of the lighting device 10 in an exploded view. The housing 12 is comprised of a back cover 20 and a front cover 22, which is provided as a frame with several windows 24 for the OLED modules 14a, 14b; 16a-c which are provided between the front and back covers 20, 22.

In FIG. 4, the OLED module 16b as an example of the first, larger type of OLED module, and the OLED module 14a, as an example of the second, smaller type of OLED modules are shown as a further exploded view.

As visible from FIG. 4, the OLED modules 14a, 14b, 16a-c are each provided as a sandwich structure comprised of a module top cover 26, the actual OLED board 28a, 28b, a module bottom cover 30 and a printed circuit board 32a, 32b.

The OLED boards 28a, b serve as the actual light emitting elements. They consist of a substrate, e. g. glass, on which the actual OLED layer is applied. The OLED boards 28a of the OLED modules 16a-c of the first type are significantly larger than the OLED boards 28b of the OLED modules 14a, 14b of the second type. In the shown example of a lighting device 10 intended as replacement of a fluorescent lamp, the OLED boards 28a, 28b have the same width but differ in length. The OLED boards 28a have a length of more than twice the length of the OLED boards 28b, and thus correspondingly a larger surface area.

Provided on the back surface of the OLED boards 28a, 28b are metal contacting pads (not shown) serving as electrical terminals. The terminals are internally connected to the electrodes of the OLED layer of the OLED board, such that, when electrical power is supplied to these terminals, light is emitted from the front surface of the OLED board 28a, 28b shown in FIG. 4.

Within each OLED module, the terminals of the OLED boards 28a, 28b are electrically contacted by contact springs 34, provided as bent sheet metal strips and arranged between the printed circuit boards 32a and 32b and the back of the OLED boards 28a, 28b. Also arranged in between the OLED boards 28a, 28b and the PCBs 32a, 32b is the module bottom cover 30 which comprises a number of cut-outs, through which the contact springs 34 provide the electrical contact.

Electrical power is supplied to the lighting device 10 via the first plug connector 18a. Each of the OLED modules 14a, 14b, 16a-c comprises a module plug connector 36 on its side facing towards the first connector 18a, and a corresponding module socket connector 38 on the opposite side (not shown). The OLED modules 14a, 14b, 16a-c are interconnected by these plug/socket connections such that electrical power is supplied from the first plug connector 18a to each of the modules.

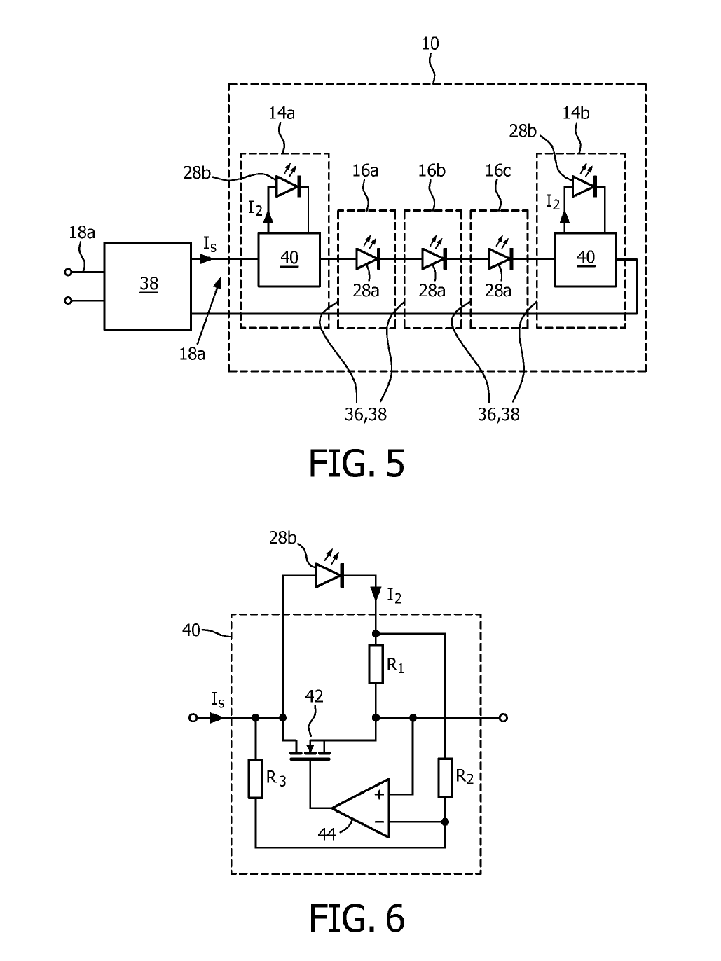

FIG. 5 shows in a schematic representation the electrical circuit of the lighting device 10. Electrical power is supplied as AC mains power. A power supply circuit 38, which in the present example is located outside of the lighting device 10, transforms the mains AC power into electrical DC power suited for operation of the OLED modules 14a, 14b, 16a-c. The power supply circuit 38 delivers to the first plug connector 18a a DC series operating current I_{S}. The OLED modules 14a, 14b, 16a-c are connected to the power supply circuit 38 in series as shown in FIG. 5.

The individual modules 14a, 14b, 16a-c are electrically interconnected by the module plug/socket connections 36, 38 as explained above.

The OLED boards 28a of the larger first type of OLED modules 16a-c are larger than the OLED boards 28b of the OLED modules 14a, 14b of the smaller second type, and thus require a higher nominal current.

As shown in the circuit of FIG. 5, the larger OLED boards 28a are directly supplied by the series operating current I_{S} Thus, in the present example the PCBs 32a of the first type of OLED modules 16a are provided without additional circuitary and only comprise the necessary electrical connection.

On the other hand, the smaller OLED boards 28b have a smaller surface area and require a smaller nominal operating current I₂. To provide this lower operating current for the second type of OLED boards 28b, which may also be designated a second device current I₂ adjustment circuits 40 are comprised within the PCBs 32a of the OLED modules 14a , 14b of the second type. The adjustment circuits 40 are driven by the series operating current I_{S}, but provide an operating current I₂ for the smaller OLED boards 28b which have a lower current value than the series operating current I_{S}.

FIG. 6 shows a first embodiment of an adjustment circuit 40. The adjustment circuit 40 comprises a MOSFET 42 as controllable bypass element connected in parallel to the OLED board 28b. A sense resistor R₁ is connected in series to the OLED board 28b. The current I₂ through the OLED board 28b leads to a voltage over the sense resistor R₁, which is fed to an operational amplifier. Resistors R₂, R₃ are part of a voltage divider circuit to provide an offset voltage to the operational amplifier 44.

In operation of the adjustment circuit 40, a portion of the series operating current I_{S} supplied at the terminals is conducted through the MOSFET bypass element 42, such that only a smaller portion I₂ flows through the OLED board 28b. The portion I₂ of the total series operating current I_{S} may be adjusted by an appropriate choice of the component values of resistors R₁-R₃.

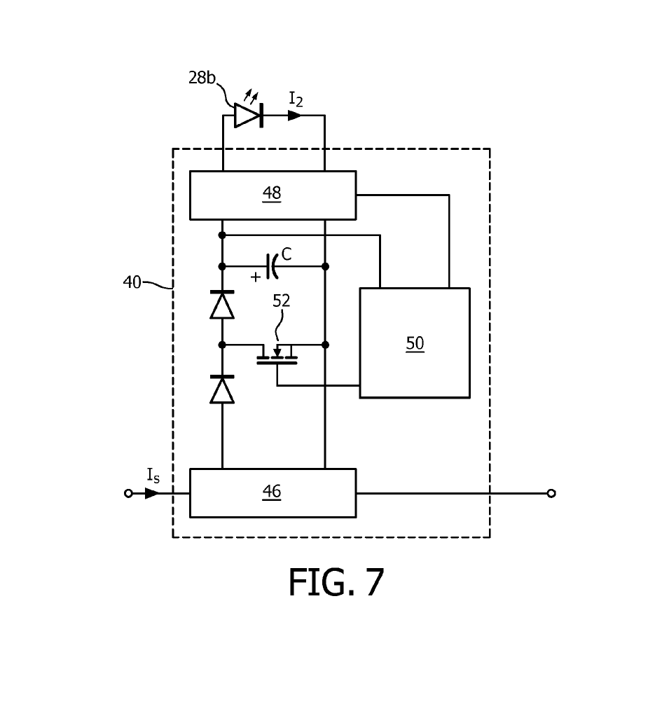

FIG. 7 shows a second embodiment of an adjustment circuit 40, comprising a filter circuit 46, a DC/DC converter circuit 48 and a controller 50. The filter 46 may be provided e. g. for EMI and may comprise an inductance and a capacitor. The controller 50 controls a MOSFET 52 arranged as controllable bypass element. A capacitor C is charged by the portion of the series operating current I_{S}, which is not bypassed by the MOSFET 52 and supplies an operating voltage for the DC/DC converter circuit 48.

The DC/DC converter circuit 48, which may e. g. be an integrated circuit switching converter, delivers the second device current I₂ to the OLED board 28b under control of the controller 50.

In operation of the adjustment circuit 40, the controller 50 operates the bypass MOSFET 52 to maintain a voltage over capacitance C appropriate as input voltage for the DC/DC converter 48. The controller 50 further controls the DC/DC converter circuit 48 to obtain a desired current value for the second device current I₂.

While the invention has been illustrated and described in detail in the drawings and foregoing description, such illustration and description are to be considered illustrative or exemplary and not restrictive; the invention is not limited to the disclosed embodiments.

For example the number of OLED modules within the lighting device may vary according to the required length and surface area. Also, different types of DC/DC controllers may be employed in the embodiment of FIG. 7.

Further variations from the disclosed embodiments can be understood and effected by those skilled in the art in practicing the claimed invention, from a study of the drawings, the disclosure and the appended claims. In the claims the word “comprising” does not exclude other elements, and the indefinite articles “a” or “an” does not exclude a plurality.

The mere fact that certain measures are recited in mutually different dependent claims does not indicate that a combination of these measures cannot be used to advantage. Any reference signs in the claims should not be construed as limiting the scope.

1. Lighting device comprising
at least a first OLED module with a first OLED element and a second OLED module with a second OLED element, said OLED elements each including a front surface for emitting light and a back surface, wherein said front surfaces of said first and second OLED elements have different size,
a power supply circuit to supply a series operating current,
where said OLED modules are electrically connected in series to said power supply circuit to be operated by said series operating current;
and where an adjustment circuit is provided to adjust a second operating current supplied to said second OLED element to a current value below the current value of said series operating current.

2. Lighting device according to claim 1, wherein
said front surface of said first OLED element has a surface area which is at least 50% larger than a surface area of said front surface of said second OLED element.

3. Lighting device according to claim 1, wherein
at least one OLED module comprises one OLED element,
and a conductor board arranged in parallel to said back surface of said OLED element, said conductor board comprising electrical conductors connected to said power supply circuit,
wherein said OLED element includes terminals for electrical supply
and wherein said terminals are electrically connected to said electrical conductors on said conductor board.

4. Lighting device according to claim 1, wherein
at least two of said OLED modules are electrically connected by a plug connector.

5. Lighting device according to claim 3, wherein
said terminals are provided on said back surface of said OLED element,
and wherein contact springs electrically connect said electrical conductors to said terminals.

6. Lighting device according to claim 5, wherein
said contact springs are bent metal sheet elements provided between said conductor board and said back side of said OLED element.

7. Lighting device according to claim 1, wherein
said OLED modules are arranged within a housing or frame.

8. Lighting device according to claim 7, wherein
a top housing is provided as a frame to hold said OLED modules without covering said front surface.

9. Lighting device according to claim 1, wherein
said OLED element of said first OLED module is directly operated by said series operating current,
and wherein said second OLED module comprises said adjustment circuit to operate said second OLED element.

10. Lighting device according to claim 1, wherein
said adjustment circuit comprises a controllable bypass element to bypass at least a portion of said series operating current from said second OLED element.

11. Lighting device according to claim 10, wherein
a control circuit is provided for controlling said controllable bypass element dependence on a second device current through said second OLED element to limit said second device current to a current value below a current value of said series operating current.

12. Lighting device according to claim 1, wherein
said adjustment circuit comprises a current sensing element electrically connected in series with said second OLED device.

13. Lighting device according to claim 1, wherein
said adjustment circuit comprises a DC/DC driver circuit supplied with electrical power by said series operating current, said DC/DC driver circuit delivering said second operating current to said second OLED element.
